(19) United States
(12) Patent Application Publication
(10) Pub. No.: US 2012/0202133 A1
(43) Pub. Date: Aug. 9, 2012

(54) FUEL CELL SEPARATOR MATERIAL, AND FUEL CELL STACK USING THE SAME

(76) Inventors: Norimitsu Shibuya, Ibaraki (JP); Tatsuo Hisada, Aichi (JP); Masayosi Huto, Aichi (JP)

(21) Appl. No.: 13/387,809

(22) PCT Filed: Jul. 29, 2010
(86) PCT No.: PCT/JP2010/062755

§ 371 Date: Apr. 27, 2012

(30) Foreign Application Priority Data
Aug. 5, 2009 (JP) 2009-182239

(51) Int. Cl. H01M 8/02; H01M 2/16; H01M 8/24; B82Y 30/00

(52) U.S. Cl. 429/468; 429/509; 977/755; 977/810

(57) ABSTRACT

A fuel cell separator material, comprising a metal base and an Au plated layer formed on the surface of the metal base, wherein the Au plated layer has a thickness of 2 to 20 nm and arithmetic mean deviation of the profile (Ra) of 0.5 to 1.5 nm measured by an atomic force microscope within a crystal grain of the metal base.

### FIELD OF THE INVENTION

The present invention relates to a fuel cell separator material comprising a metal base and an Au plated layer formed on a surface of the metal base, and a fuel cell stack using the same.

### DESCRIPTION OF THE RELATED ART

A polymer electrolyte fuel cell separator has electrical conductivity, electrically connects each single cell of the fuel cell, collects energy (electricity) produced on each single cell, and has flow paths for a fuel gas and air (oxygen) that are provided to each single cell. The separator is also referred to as an interconnector, a bipolar plate or a current collector.

Traditionally, as the fuel cell separator, a carbon plate on which gas flow paths are formed has been used. However, it is undesirable in that material and processing costs are high. On the other hand, when a metal plate is used in place of the carbon plate, it might undesirably be corroded and dissolved at high temperature under oxidizing atmosphere. To avoid this, there are known technologies that 0.01˜0.06 μm thick Au plating is coated on a surface of a stainless steel plate (see Patent Literature 1) and a noble metal selected from Au, Ru, Rh, Pd, Os, Ir, Pt or the like is sputter-deposited to form an electrical conductive portion on a stainless steel plate (see Patent Literature 2).

In addition, there are reported technologies that gold is directly plated in an acidic bath with no pretreatment (see Patent Literature 3), and that an oxide layer is formed on a surface of a stainless steel plate and gold is then plated (see Patent Literature 4).

### PRIOR ART LITERATURE

### Patent Literature

[Patent Literature 1] Japanese Unexamined Patent Publication (Kokai) Hei 10-228914
[Patent Literature 2] Japanese Unexamined Patent Publication (Kokai) 2001-297777
[Patent Literature 3] Japanese Unexamined Patent Publication (Kokai) 2004-296381
[Patent Literature 4] Japanese Unexamined Patent Publication (Kokai) 2007-257883

### SUMMARY OF THE INVENTION

### Problems to be Solved by the Invention

However, when the thickness of the gold plating is less than 20 nm in order to decrease costs, coating defects may be easily introduced, and the corrosion resistance of the fuel cell separator cannot be fully provided. Especially, the fuel cell separator is in a severe environment in terms of the corrosion resistance, since it is disposed under acidic atmosphere.

In other words, an object of the present invention is to provide a fuel cell separator material and a fuel cell stack having excellent corrosion resistance even though the Au plated layer formed on the surface of the metal base is thin.

### Means for Solving the Problems

The present invention provides a fuel cell separator material, comprising a metal base and an Au plated layer formed on the surface of the metal base, wherein the Au plated layer has a thickness of 2 to 20 nm and arithmetic mean deviation of the profile (Ra) of 0.5 to 1.5 nm measured by an atomic force microscope within a crystal grain of the metal base.

Preferably, the Au plated layer is formed by electroplating using an Au plating bath having a pH of 1.0 or less and containing sodium bisulfate as a conductive salt.

Preferably, the metal base is stainless steel.

Preferably, the metal base has a thickness of 0.05 to 0.3 mm.

Preferably, the Au plated layer is subjected to a pinhole sealing treatment.

Preferably, the pinhole sealing treatment is conducted by an electrolytic treatment of the Au plated layer in a mercapto-based solution.

Preferably, the Au plated layer has a thickness of 5 to 20 nm.

Preferably, the fuel cell separator material of the present invention may be used in a polymer electrolyte fuel cell or a direct methanol polymer electrolyte fuel cell.

A fuel cell separator of the present invention uses the separator material.

A fuel cell stack of the present invention uses the fuel cell separator material.

### Effect of the Invention

According to the present invention, the corrosion resistance can be improved even though the Au plated layer formed on a surface of a metal base is thin.

### BRIEF DESCRIPTION OF THE DRAWINGS

FIG. 1 is a TEM image of a section of the fuel cell separator material including the Au plated layer with a thickness of 7 nm;

FIG. 2 is a TEM image of a section of the fuel cell separator material including the Au plated layer with a thickness of 24 nm;

FIG. 3 is a section view of a fuel cell stack (single cell) according to the embodiment of the present invention;

FIG. 4 is a section view of a flat type fuel cell stack according to the embodiment of the present invention; and

FIG. 5 is graph showing amount of metal ion dissolution of samples obtained after a pinhole sealing treatment and immersion in a sulfuric acid solution for one week and two weeks.

### DESCRIPTION OF THE EMBODIMENTS

Embodiments of the fuel cell separator material according to the embodiments of the present invention will be described below. The symbol “%” herein refers to % by mass, unless otherwise specified.

The term “fuel cell separator” herein refers to a fuel cell separator which has electrical conductivity, connects each single cell electrically, collects energy (electricity) produced on each single cell, and has flow paths for a fuel gas or air (oxygen) that is provided to each single cell. The separator is also referred to as an interconnector, a bipolar plate and a current collector.

Accordingly, the fuel cell separator includes a separator having concave-convex flow paths formed on a surface of a plate-like base, as well as a separator having flow paths with open holes for a gas or methanol formed on a surface of a plate-like base, such as the above-mentioned passive type DMFC separator, which will be described below for detail.

### <Metal Base>

The fuel cell separator material requires corrosion resistance and conductivity, and the base (metal base) requires corrosion resistance. It is preferred that stainless steel having good corrosion resistance and available at relatively low costs be used as the metal base.

The kind of the stainless steel is not especially limited, but includes SUS 304 and SUS 316L in compliance with JIS standard. In terms of excellent corrosion resistance, SUS 316L (stainless steel to which about 2.5% of Mo is added) is preferable.

The shape of the metal base is also not especially limited so long as Au can be plated. However, since the metal base is press-formed to the separator shape, the shape is preferably a plate. Specifically, the plate has preferably a thickness of 0.05 to 0.3 mm.

From the standpoint of forming the Au plated layer smoothly, the surface of the metal base may be smoothed. When the stainless steel is used as the metal base, there are known surface treatment methods including a bright annealing (BA), polish finishing and the like. According to the present invention where a thin Au plated layer having a thickness of 20 nm or less is formed, BA-treated stainless steel is preferable.

### <Au Plated Layer>

An Au plated layer having a thickness of 2 to 20 nm is formed on the surface of the metal base. The thickness of the Au plated layer is 2 nm or more in view of the corrosion resistance and is 20 nm or less in view of costs. In order to provide good corrosion resistance and to decrease costs, the thickness of the Au plated layer is preferably 5 to 20 nm, and more preferably 5 to 10 nm. The thickness of the Au plated layer can be calculated by an electrolysis process or from a transmission electron microscope (TEM) image.

Arithmetic mean deviation of the profile (Ra) of the Au plated layer measured by an atomic force microscope within a crystal grain of the metal base is 0.5 to 1.5 nm. Through diligent studies, the present inventors found that, in the thin Au plated layer (a thickness of 20 nm or less), the greater Ra of the surface is, the more the metal is dissolved from the metal base. The reason is not clear, but it is considered that the Au plated layer having greater Ra is intensively electrocrystallized on the specific location of the metal base upon electroplating, thinner parts may be correspondingly produced in the plated layer, and coating defects may be introduced.

The electrodeposition of Au on the metal base is different between the location within a crystal grain or location on the grain boundary of the metal base. Specifically, concave electrodepositon is formed on the grain boundary of the metal base. Therefore, when Ra on the locations containing the grain boundary of the metal base is measured by AFM, the measured value of Ra is increased. Accordingly, Ra measured within a crystal grain of the metal base is employed as Ra of the Au plated layer according to the present invention.

In terms of decreasing the costs, it is possible to plate Au only on the parts requiring the conductivity, such as the parts which contact with the electrodes when the fuel cell separator material is made into the fuel cell separator.

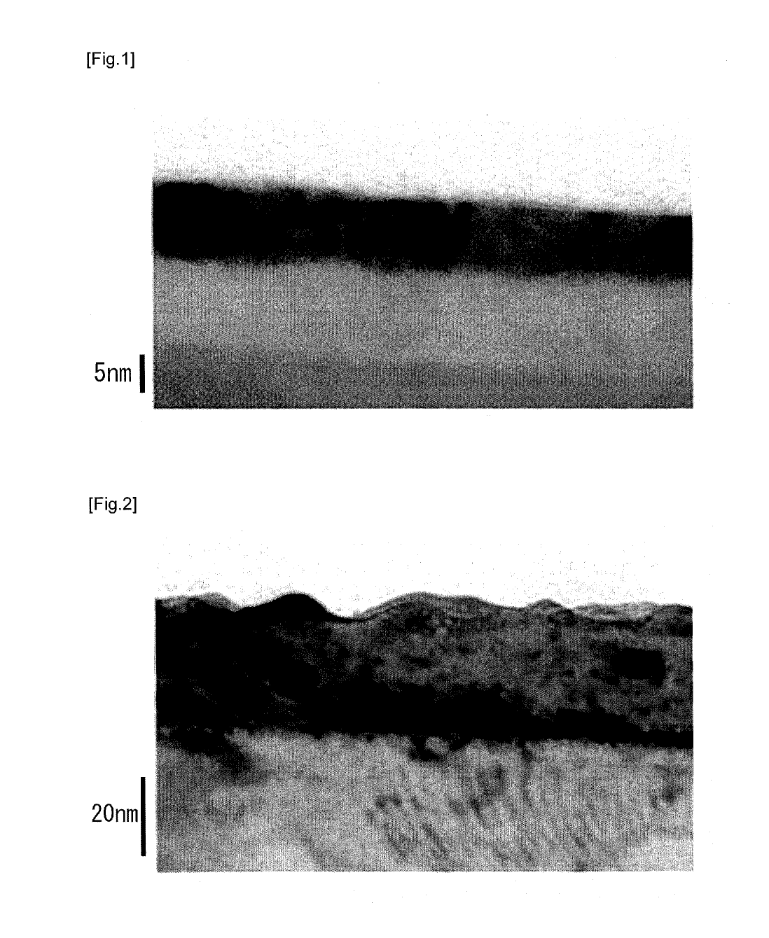

FIG. 1 is a TEM image of a section of the fuel cell separator material including the Au plated layer with a thickness of 7 nm obtained under the conditions as described in Example 1 later. FIG. 2 is a TEM image of a section of the fuel cell separator material including the Au plated layer with a thickness of 24 nm obtained similarly.

It can be seen that the surface of the Au plated layer is flat, when the thickness of the Au plated layer is 20 nm.

When the smoothness of the thin and soft Au plated layer having the thickness of 20 nm or less is evaluated using a contact type surface roughness tester, concave-convex at nanometer level are difficult to be evaluated, and the roughness of the metal base such as stainless steel is undesirably measured instead. Accordingly, a non-contact type atomic force microscope (AFM) is used for evaluation of the smoothness of the thin Au layer in the present invention.

When Ra of the Au plated layer measured by AFM is 1.5 nm or less, the amount of metal ion dissolution is significantly decreased. So, the Ra is defined within 0.5 to 1.5 nm. It is preferred that the Ra of the Au plated layer be smaller. However, it is practically difficult to form the plated layer with the Ra of less than 0.5 nm.

A method for providing the Au plated layer with the Ra of 1.5 nm or less includes electroplating using an acidic Au plating bath having a pH of 1.0 or less and containing sodium bisulfate as a conductive salt. In this case, the composition of the Au plated bath comprises an Au salt, sodium bisulfate and other additives as appropriate. As the Au salt, a gold cyanide salt, a non-cyanide gold salt (such as gold chloride) and the like can be used. The gold concentration in the Au salt can be about 1 to 100 g/L. The concentration of sodium bisulfate can be about 50 to 100 g/L.

When the acidic Au plating bath having a pH of 1.0 or less is used, a Cr oxide layer on the surface is easily removed in case of stainless steel is used as a metal base, and adhesion of the Au plated layer can be improved.

Also, it is preferred that the acidic Au plating bath be used, and Au be directly plated on the metal base surface such as the stainless steel surface. This is because of the following facts. Traditionally, as to a connector material, the base is Ni first plating is plated on the base and the Au is then plated. However, since Ni has weak acid resistance, Ni plating is therefore peeled in the acidic Au plated bath having a pH of 1.0 or less. In addition, the acidic Au plating bath having a pH of 1.0 or less can plate the metal base at high current density. Therefore, a large amount of hydrogen is produced upon plating to activate the surface of the stainless steel, and Au is easily attached thereto.

As to the Au plating conditions, when the current density is low, a current is concentrated on a convex part of the metal base, so that the plated layer is difficult to be flat. When the temperature of the plating bath is low, the plated layer may be difficult to be flat.

The concentration of gold in the plating solution is preferably 1 to 4 g/L, more preferably 1.3 to 1.7 g/L. When the concentration of gold is less than 1 g/L, current efficiency is decreased, so that the plated layer may be difficult to be flat.

### <Pinhole Sealing Treatment>

It is preferred that the Au plated layer be seal-treated. If the plating defects are introduced to the Au plated layer, the pinhole sealing treatment can fill the defects and maintain the corrosion resistance. A variety of methods of seal-treating the Au plating are known. Preferably, the Au plated layer is subjected to electrolytic treatment in a mercapto-based solution. The mercapto-based solution is obtained by dissolving a compound having a mercapto group in water. The compound having a mercapto group includes a mercapto benzothiazole derivative described in Japanese Unexamined Patent Publication (Kokai) 2004-265695.

### <Fuel Cell Separator>

Then, the fuel cell separator made with the fuel cell separator material according to the present invention will be described below. The fuel cell separator is made by working the above-mentioned fuel cell separator material into the predetermined shape, and comprises reaction gas flow paths or reaction liquid flow paths (channels or openings) for flowing a fuel gas (hydrogen), a fuel liquid (methanol), air (oxygen), cooling water and the like.

### <Layered Type (Active Type) Fuel Cell Separator>

FIG. 3 shows a section of a single cell of the layered type (active type) fuel cell. In FIG. 3, current collector plates 140A and 140B are disposed outside of a separator 10 as described later. Generally, when the single cells are layered to form a stack, only a pair of the current collector plates is disposed only on both ends of the stack.

The separator 10 has electrical conductivity, contacts with MEA as described later to collect current, and electrically connects respective single cells. In addition, as described later, the separator 10 has channels as flow paths for flowing a fuel gas and air (oxygen).

In FIG. 3, Membrane Electrode Assembly (MEA) 80 is made by laminating an anode electrode 40 and a cathode electrode 60 on both sides of a polymer electrolyte membrane 20. On the surfaces of the anode electrode 40 and the cathode electrode 60, an anode side gas diffusion layer 90A and a cathode side gas diffusion layer 90B are laminated, respectively. The Membrane Electrode Assembly herein may be a laminate including the gas diffusion layers 90A and 90B. When the gas diffusion layers are formed on the surfaces of the anode electrode 40 and the cathode electrode 60, the laminate of the polymer electrolyte membrane 20, the anode electrode 40 and the cathode electrode 60 may be referred to as the Membrane Electrode Assembly.

On both sides of the MEA 80, separators 10 are disposed facing to the gas diffusion layers 90A and 90b, and sandwich the MEA 80. Flow paths 10L are formed on the surfaces of the separators 10 at the sides of the MEA 80, and gas can enter and exit into/from an internal spaces 20 surrounded by gaskets 12, the flow paths 10L and the gas diffusion layer 90A (or 90B) as described later.

A fuel gas (hydrogen or the like) flows into the internal spaces 20 at the anode electrode 40, and an oxidizing gas (oxygen, air or the like) flows into the internal spaces 20 at the cathode electrode 60 to undergo electrochemical reaction.

The outside peripherals of the anode electrode 40 and the gas diffusion layer 90A are surrounded by a frame-like seal member 31 having the almost same thickness as the total thickness of the anode electrode 40 and the gas diffusion layer 90A. A substantially frame-like gasket 12 is inserted between the seal member 31 and the peripheral of the separator 10 such that the separator is contacted with the gasket 12 and the flow paths 10L are surrounded by the gasket 12. The current collector plate 140A (or 140B) is laminated on the outer surface (opposite surface of the MEA 80 side) of the separator 10, and a substantially frame-like seal member 32 is inserted between the current collector plate 140A (or 140B) and the peripheral of the separator 10.

The seal member 31 and the gasket 12 form a seal to prevent the fuel gas or the oxidizing gas from leaking outside the cell. When a plurality of the single cells are laminated to form a stack, a gas flows into a space 21 between the outside of the separator 10 and the current collector plate 140A (or 140B); the gas being different from that flowing into the space 20. (When the oxidizing gas flows into the space 20, hydrogen flows into the space 21.) Therefore, the seal member 32 is also used as the member for preventing the gas from leaking outside the cell.

The fuel cell is includes the MEA 80 (and the gas diffusion layers 90A and 90B), the separator 10, the gasket 12 and the current collectors 140A and 140B. A plurality of the fuel cells is laminated to form a fuel cell stack.

The layered type (active type) fuel cell shown in FIG. 3 can be applied not only to the above-mentioned fuel cell using hydrogen as the fuel, but also to the DMFC using methanol as the fuel.

### <Flat Type (Passive Type) Fuel Cell Separator>

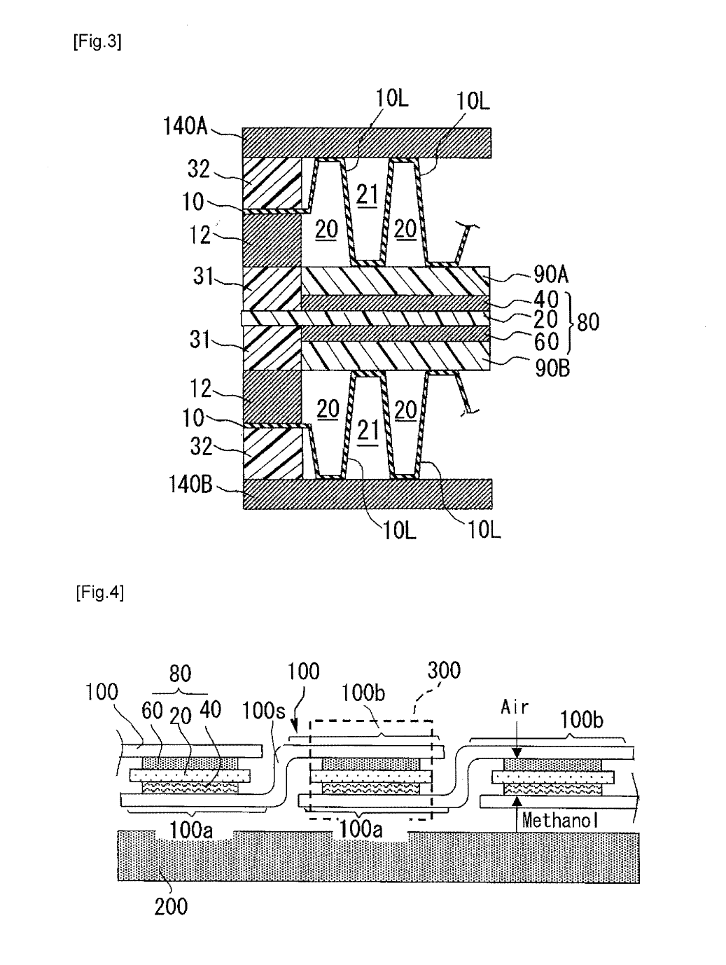

FIG. 4 shows a section of a single cell of the flat type (passive type) fuel cell. In FIG. 4, current collector plates 140 are disposed outside of a separator 100, respectively. Generally, when the single cells are layered to form a stack, a pair of the current collector plates is disposed only on both ends of the stack.

In FIG. 4, the structure of the MEA 80 is the same as that in FIG. 3, so the same components are designated by the same symbols and the descriptions thereof are omitted. (In FIG. 4, the gas diffusion layers 90A and 90B are omitted, but there may be the gas diffusion layers 90A and 90B.)

In FIG. 4, the separator 100 has electrical conductivity, collects electricity upon contact with the MEA, and electrically connects each single cell. As described later, holes are formed on the separator 100 for flowing a fuel liquid and air (oxygen).

The separator 100 has a stair 100s roughly on the center of an elongated tabular base so as to make a section crank shape, and includes an upper piece 100b disposed upper via the stair 100s and a lower piece 100a disposed below via the stair 100s. The stair 100s extends vertically in the longitudinal direction of the separator 100.

A plurality of the separators 100 are arranged in the longitudinal direction, spaces are provided between the lower pieces 100a and the upper pieces 100b of the abutted separators 100, and the MEAs 80 are inserted into the spaces. The structure that the MEA 80 is sandwiched between two separators 100 constitutes a single cell 300. In this way, a stack that a plurality of the MEAs 80 are connected in series via the separators 100 is provided.

The flat type (passive type) fuel cell shown in FIG. 4 can be applied not only to the above-mentioned DMFC using methanol as the fuel, but also to the fuel cell using hydrogen as the fuel. The shape and the number of the openings of the flat type (passive type) fuel cell separator are not limited, the openings may be not only holes but also slits, or the whole separator may be a net.

### <Fuel Cell Stack>

The fuel cell stack of the present invention is obtained by using the fuel cell separator material of the present invention.

The fuel cell stack has a plurality of cells connected in series where electrolyte is sandwiched between a pair of electrodes. The fuel cell separator is inserted between the cells to block the fuel gas or air. The electrode contacted with the fuel gas (H₂) is a fuel electrode (anode), and the electrode contacted with air (O₂) is an air electrode (cathode).

Non-limiting examples of the fuel cell stack have been described referring to FIGS. 3 and 4.

### Example

### <Sample Preparation>

A stainless steel plate (SUS 316L) having a thickness of 0.1 mm was pre-treated with a commercially available degreasing liquid Pakuna 105 to degrease electrolytically, washed with water, washed with sulfuric acid, and further washed with water.

Then, the following Au plating bath was used to directly plate the pre-treated stainless steel plate with Au in a thickness of 5 nm, whereby each fuel cell separator material is produced.

The Au plating solution (cyanide) contained a gold cyanide salt (gold concentration: 1 to 4 g/L) and sodium bisulfate 70 g/L and had a pH of 1.0 or less.

For comparison, the Au plating was conducted as described above with the exception of adding no sodium bisulfate to the Au plating solution and of adding 10% by mass of hydrochloric acid as the conductive salt instead.

The arithmetic mean deviation of the profile Ra and the corrosion resistance of each fuel cell separator material thus produced were measured.

### <Arithmetic Mean Deviation of the Profile>

The Ra of the Au plated layer was measured by the atomic force microscope (SPM-9600 manufactured by Shimadzu Corporation) in a dynamic mode (non-contact system) within a scan range of 1 μm×1 μm at a scan speed of 0.8 Hz. The area corresponding to the place within a crystal grain of the stainless steel plate before plating Au was measured 3 times (n=3), and the average value is used as the Ra value.

### <Corrosion Resistance>

Each fuel cell separator material was cut out to a size of 40×50 mm, was immersed in 600 ml of a 10 g/L sulfuric acid solution at 95° C. for 72 hours, and was pulled up. Fe, Ni and Cr ions in the solution were quantified by an ICP analysis to measure the amount of dissolved metal.

Two typical properties needed for the fuel cell separators are as follows: low contact resistance (10 mΩ·cm² or less) and corrosion resistance under the usage environment (low contact resistance and no toxic ion dissolution after the corrosion resistance test).

The results are shown in Table 1.

TABLE 1

| | | | | | | Corrosion |
|---|---|---|---|---|---|---|
| | | | | Ra of Au plated layer | | resistance |
| | Au plating conditions | | | | By contact | Amount of |
| | Current | Plating bath | | | type | metal ion |
| | density | temperature | | By AFM | roughness | dissolution |
| | (A/dm2) | (° C.) | Conductive salt | (nm) | tester (μm) | (mg/600 ml) |
| Example 1 | 1.8 | 40 | Sodium bisulfate | 0.5 | 0.04 | 0.65 |
| Example 2 | 5.5 | 20 | Sodium bisulfate | 0.9 | 0.03 | 0.70 |
| Example 3 | 5.5 | 30 | Sodium bisulfate | 1.1 | 0.04 | 0.37 |
| Example 4 | 5.5 | 40 | Sodium bisulfate | 0.6 | 0.04 | 0.55 |
| Example 5 | 8 | 30 | Sodium bisulfate | 0.5 | 0.04 | 0.40 |
| Example 6 | 8 | 40 | Sodium bisulfate | 1.2 | 0.04 | 0.28 |
| Comparative Example 1 | 1.8 | 30 | Hydrochloric acid | 2.8 | 0.04 | 38.00 |
| Comparative Example 2 | 5.5 | 30 | Hydrochloric acid | 2.1 | 0.04 | 1.30 |
| Comparative Example 3 | 8 | 30 | Hydrochloric acid | 2.0 | 0.05 | 1.00 |
| Comparative Example 4 | 1.8 | 20 | Sodium bisulfate | 2.2 | 0.05 | 36.00 |
| Comparative Example 5 | 1.8 | 30 | Sodium bisulfate | 2.2 | 0.04 | 25.80 |
| Comparative Example 6 | 8 | 20 | Sodium bisulfate | 2.7 | 0.04 | 24.60 |

| | | | | |
|---|---|---|---|---|
| Comparative Example 7 | Stainless steel base | 0.6(Note) | 0.04(Note) | 80.00 |

Note:
Ra in Comparative Example 7 is the surface roughness of the base.

As shown in Table 1, in Examples 1 to 6 each having the arithmetic mean deviation of the profile Ra of 1.5 nm or less of the Au layer surface measured by the atomic force microscope (AFM), the amount of metal ion dissolution are low and the corrosion resistance was excellent. When the Ra was measured by the contact type surface roughness tester, it was impossible to measure the Ra at nm level, and the Ra was within the range of 0.03 to 0.05 μm. So, the difference between the samples could not be distinguished.

On the other hand, in Comparative Examples 1 to 6 each having the arithmetic mean deviation of the profile Ra of exceeding 1.5 nm of the Au layer surface measured by the atomic force microscope (AFM), the amount of metal ion dissolution are 1 mg/600 ml or more and the corrosion resistance was poor as compared with Examples.

In Comparative Examples 1 to 3, hydrochloric acid was used as the conductive salt. In Comparative Examples 4 and 5, the current density was low (1.8 A/dm²) and the bath temperature was 30° C. or less. In Comparative Example 6, the bath temperature was low (20° C.). In Comparative Example 7, Au was not plated, and the Ra in Table 1 was the surface roughness of the base.

### <Pinhole Sealing Treatment>

Next, the pinhole sealing treatment of the Au layer was conducted in a 500 ppm solution of a Na salt of 2-mercaptobenzothiazole (MBT-Na) at ambient temperature, provided that the sample of Example 3 was used as an anode, and SUS 316L was used as a cathode. Thus, the sample of Example 10 was provided. Mercaptobenzothiazole is described in Japanese Unexamined Patent Publication (Kokai) 2004-265695.

Then, the sealed sample was cut out to a size of 40×50 mm, was immersed in 600 ml of a 10 g/L sulfuric acid solution at 95° C. for one week and two weeks. The amount of metal ion dissolution was measured as described above.

As Comparative Example 11, the sample of Example 3 was used with no pinhole sealing treatment, and was immersed in the sulfuric acid solution for one week and two weeks as in Example 10.

As Comparative Example 12, the sample of Example 3 was immersed in a water solution to which NaOH was added to adjust pH to 8.5 at ambient temperature for 30 seconds. Then, the pinhole sealing treatment of the Au layer was conducted. The resultant sample was immersed in the sulfuric acid solution for one week and two weeks as in Example 10.

As Comparative Example 13, the sample of Example 3 was immersed in a water solution of 500 ppm of potassium molybdate at ambient temperature for 30 seconds. Then, the pinhole sealing treatment of the Au layer was conducted. The resultant sample was immersed in the sulfuric acid solution for one week and two weeks as in Example 10.

As Comparative Example 14, the sample of Example 3 was immersed in a water solution of 500 ppm of potassium molybdate at ambient temperature and at a bath voltage of 2V for 3 seconds, when the sample of Example 3 was used as an anode, and SUS 316L was used as a cathode. Then, the pinhole sealing treatment of the Au layer was conducted. The resultant sample was immersed in the sulfuric acid solution for one week and two weeks as in Example 10.

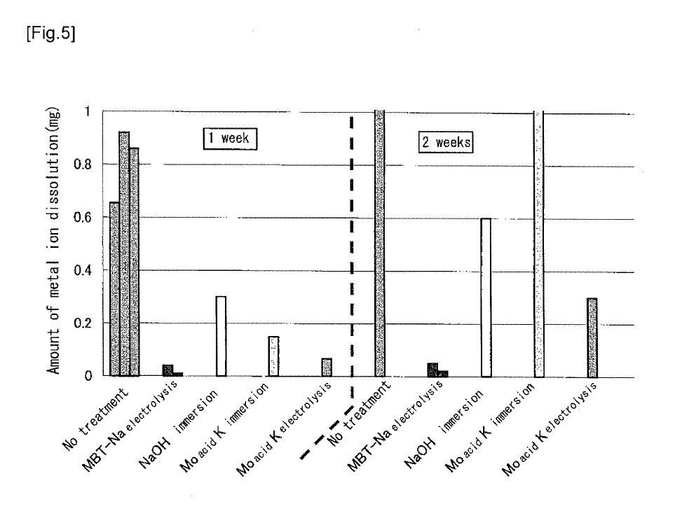

The results are shown in Table 2 and FIG. 5. In FIG. 5, Mo acid K represents potassium molybdate (K₂MoO₄). The unit in Table 2 is mg similar to that in FIG. 5.

TABLE 2

| | Immersed for one week | | | | Immersed for two weeks | | |
|---|---|---|---|---|---|---|---|
| | | | | Average | | | Average |
| | Data | | | value | Data | | value |
| Example 10 | 0.04 | 0.01 | | 0.03 | 0.05 | 0.02 | 0.04 |
| Comparative | 0.65 | 0.92 | 0.86 | 0.81 | 1.95 | | 1.95 |
| Example 11 | | | | | | | |
| Comparative | 0.30 | | | 0.30 | 0.60 | | 0.60 |
| Example 12 | | | | | | | |
| Comparative | 0.15 | | | 0.15 | 1.50 | | 1.50 |
| Example 13 | | | | | | | |
| Comparative | 0.07 | | | 0.07 | 0.30 | | 0.30 |
| Example 14 | | | | | | | |

As apparent from Table 2 and FIG. 5, the corrosion resistance is improved when the pinhole sealing treatment is conducted in 2-mercaptobenzothiazole (mercapto-based solution) as compared with that conducted in the inorganic-based potassium molybdate solution.

### DESCRIPTION OF REFERENCE NUMERALS

10, 100 Separator
12, 12B Gasket
20 Polymer electrolyte membrane
40 Anode electrode
60 Cathode electrode
80 Membrane Electrode Assembly (MEA)

1. A fuel cell separator material, comprising a metal base and an Au plated layer formed on the surface of the metal base, wherein the Au plated layer has a thickness of 2 to 20 nm and arithmetic mean deviation of the profile (Ra) of 0.5 to 1.5 nm measured by an atomic force microscope within a crystal grain of the metal base.

2. The fuel cell separator material according to claim 1, wherein the Au plated layer is formed by electroplating using an Au plating bath having a pH of 1.0 or less and containing sodium bisulfate as a conductive salt.

3. The fuel cell separator material according to claim 1, wherein the metal base is stainless steel.

4. The fuel cell separator material according to claim 2, wherein the metal base is stainless steel.

5. The fuel cell separator material according to claim 1, wherein the metal base has a thickness of 0.05 to 0.3 mm.

6. The fuel cell separator material according to claim 2, wherein the metal base has a thickness of 0.05 to 0.3 mm.

7. The fuel cell separator material according to claim 3, wherein the metal base has a thickness of 0.05 to 0.3 mm.

8. The fuel cell separator material according to claim 1, wherein the Au plated layer is subjected to a pinhole sealing treatment.

9. The fuel cell separator material according to claim 8, wherein the pinhole sealing treatment is conducted by an electrolytic treatment of the Au plated layer in a mercapto-based solution.

10. The fuel cell separator material according to claim 1, wherein the Au plated layer has a thickness of 5 to 20 nm.

11. The fuel cell separator material according to claim 1 for use in a polymer electrolyte fuel cell.

12. The fuel cell separator material according to claim 11 which is used for use in a direct methanol polymer electrolyte (DMFC) fuel cell.

13. A fuel cell separator using the separator material according to claim 1.

14. A fuel cell stack using the fuel cell separator material according to claim 1.
